(19) United States
(12) Patent Application Publication
(10) Pub. No.: US 2010/0306155 A1
(43) Pub. Date: Dec. 2, 2010

(54) SYSTEM AND METHOD FOR VALIDATING SIGNATORY INFORMATION AND ASSIGNING CONFIDENCE RATING

(76) Inventor: Mark D. Giannetto, Napoleon, OH (US)

Correspondence Address: FRASER CLEMENS MARTIN & MILLER LLC, 28366 KENSINGTON LANE, PERRYSBURG, OH, 43551, US

(21) Appl. No.: 12/788,909

(22) Filed: May 27, 2010

Related U.S. Application Data
(60) Provisional application No. 61/182,421, filed on May 29, 2009.

(51) Int. Cl. G06N 5/02; G06F 17/30; G01S 19/00

(52) U.S. Cl. 706/47; 706/52; 342/357.2; 707/758; 707/E17.044

(57) ABSTRACT

A data analysis system includes a database including a plurality of official records, a user interface for receiving a signatory information, a processor in communication with the database and the user interface, wherein the processor compares the signatory information and a number of the official records based upon an instruction set and assigns a confidence factor to the signatory information in response to the comparison of the signatory information and the number of the official records.

### CROSS-REFERENCE TO RELATED APPLICATIONS

The present application claims priority to U.S. Provisional Application Ser. No. 61/182,421 filed May 29, 2009, hereby incorporated herein by reference in its entirety.

### FIELD OF THE INVENTION

The present invention relates to data analysis and comparison. More particularly, the invention is directed to a system and a method for verifying signatory information.

### BACKGROUND OF THE INVENTION

Currently, there is considerable expense in gathering and validating signatory information. For example, a typical petition campaign in Ohio costs on the order of one million dollars. Specifically, Ohio includes two phases which return validation results (with reasons for each signatory information failure, upon request) from raw signatory information given to a County Board of Elections in the petition process for referenda, and Constitutional Amendments.

The first phase involves requesting an application for petition permission. In the first phase, the application must be accompanied with 1000 valid signatures. Typically, more signatures are submitted; however, only 1000 total signatures must be valid.

The second phase includes a submission of a totality of signatures to an appropriate Board of Elections (BOE) for validation. Specifically, petition booklets containing signatory information are submitted to the BOE for “Official Validation”. A methodology for each BOE can vary, but each examination of a set of signatory information concludes with a comparison of signatory information and official records by an official of the office and witnessed by operatives of any interested registered political parties in that county, the results of which are typically final and indisputable. It is understood that every state has different administrative rules, and laws, for its political process and the privacy of its citizens.

Minimizing costs while ensuring that the statutory minimum number of “valid” signatory responses per political subdivision is gathered is a beneficial goal.

One long-established method of handling this task is to over-gather information. However, utilizing this method still results in nearly half of all petition gathering projects failing to meet one or more of the relevant statutory requirements, resulting in a total failure of those projects and loss of the money spent to acquire the signatures. As an alternative, real-time validation and reporting is available. However, it may not be cost effective to place adequate quantities of the necessary real-time technology (self-communicating digital pens or biometrics, web connected PDAs, laptops, and/or GPS systems) in the field. In certain instances, currently available real-time reporting methods used for validating signatory information may be cost prohibitive.

It would be desirable to develop a data analysis system and a method for comparing, verifying, and validating a signatory information, wherein the system and the method provide near real-time validation of the signatory information, while minimizing overall cost of the validation procedure.

### SUMMARY OF THE INVENTION

Concordant and consistent with the present invention, a data analysis system and a method for comparing, verifying, and validating a signatory information, wherein the system and the method provide near real-time validation of the signatory information, while minimizing overall cost of the validation procedure, has surprisingly been discovered.

In one embodiment, a data analysis system comprises: a database including a plurality of official records; a user interface for receiving a signatory information; and a processor in communication with the database and the user interface, wherein the processor compares the signatory information and a number of the official records based upon an instruction set and assigns a confidence factor to the signatory information in response to the comparison of the signatory information and the number of the official records.

The invention also provides methods for validating signatory information.

One method comprises the steps of: a) providing a database including a plurality of official records; b) providing a user interface for receiving a signatory information; c) comparing the signatory information to a number of the official records; and d) assigning a confidence factor to the signatory information based upon step c).

Another method comprises the steps of: providing a database including a plurality of official records wherein each of the official records includes an identification data associated with a particular person; providing a user interface for receiving a user-provided signatory information; generating a model for comparing the signatory information to at least a portion of the official records; assigning a confidence factor to the signatory information based upon the model; and validating the signatory information based upon a threshold value for the confidence factor.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a data analysis system according to an embodiment of the present invention; and

FIG. 2 is a schematic flow diagram of a rules-based model according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

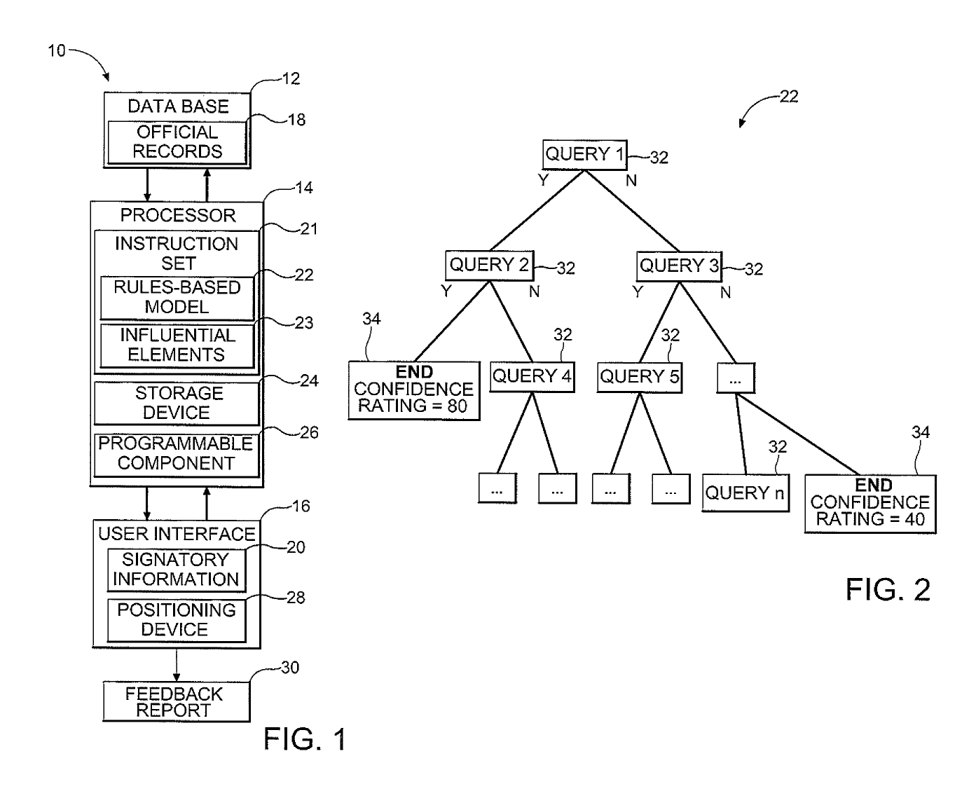

Referring to FIGS. 1 and 2, there is illustrated a data analysis system 10 according to an embodiment of the present invention. As shown, the data analysis system 10 includes a database 12, a processor 14, and a user interface 16.

The database 12 is in data communication with the processor 14. As a non-limiting example, the database 12 is an SQL database adapted to be searched and queried by the processor 14. However, other languages and protocols may be used for processor-database compatibility. As shown, the database 12 includes a plurality of official records 18, wherein each of the official records 18 contains a personal information (i.e. an identification data) such as a name, an address, a signature sample, and other personal information available through public records and private agencies. As a non-limiting example, the official records 18 may be analogous to information presented in conventional petition booklets used by a Board of Elections.

In certain embodiments, the official records 18 are converted into a proprietary standardized and normalized database table or set of tables and indices against which the processor 14 can be singly coded to search. It is understood that a cumulative library of normalizing scripts can be included to provide a means for the creation of mailing lists from disparate incoming files.

Conventional records of identification data represent addresses as abstract numbers and arbitrary road names. However, both the federal government and the individual states currently use global positioning technology (latitude in decimal, longitude in decimal, and altitude in decimal—all of which are augmented by a live digital system of virtual feedback adjustments—generally run from Department of Transportation garage benchmarks) to describe the location of a household, with the “address” reduced to a label for an associated set of global coordinates. Accordingly, the database 12 of the data analysis system 10 is adapted to record and convert both the abstract addresses and the global position addresses.

The processor 14 is in communication with the database 12 and the user interface 16. As shown, the processor 14 analyzes a user-provided signatory information 20 and compares the signatory information 20 to an associated official record 18 stored in the database 12. It is understood that the processor 14 may compare the signatory information 20 to any subset of the official records 18, as desired. Specifically, the analysis and comparison performed by the processor 14 is based upon an instruction set 21. The instruction set 21, which may be embodied within any computer readable medium, includes algorithms, formulas, and processor executable instructions for configuring the processor 14 to perform a variety of tasks.

As a non-limiting example, the instruction set 21 includes a means for generating a confidence factor (rating) for each set of the analyzed signatory information 20. As shown, the instruction set 21 includes a rules-based model 22 with diverging paths, wherein the rules represent a number of queries on the database 12. It is understood that the instruction set 21 may include any fuzzy logic, Bayesian networks, decision tree algorithms, machine learning algorithms, or other artificial intelligence techniques to factor in as many of a plurality of influential elements 23 as can be identified and thereby assign a confidence factor (rating) to each set of the analyzed signatory information 20. It is understood that the parameters of the rules-based model 22 or algorithm may be set to find a threshold point or “test” at which the number of sets of the signatory information 20 that pass the “test” (i.e. potentially valid) but will eventually fail Official Validation at the BOE substantially matches the number of sets of the signatory information 20 that fail the “test” but will eventually pass the Official Validation at the BOE. This ‘fuzzy’ operation achieves the goal of generating an absolute signatory number for an office, a county, or a totality, without a one-to-one association of absolute validity of individual sets of the signatory information 20. It is further understood that certain sets of the signatory information 20 may be analyzed with such a high level of confidence that the processor 14 labels the particular set of the signatory information 20 a “BINGO” or high validity assurance stamp. It is understood that the rules-based model 22 or algorithm represented by the instruction set 21 may be a branching confidence tree of queries which terminates positively or negatively at multiple points within the tree (network), or it can reach an endpoint with a pre-determined confidence factor (rating).

In certain embodiments, the instruction set 21 includes the influential elements 23 by which the signatory information 20 and a number of official records 18 are compared. As a non-limiting example, the influential elements 23 include at least one of: a name matching; a name partial matching (last name then first name); a full address match attempted; a numerical part of address matching; a road name matching; a soundex matching; a sequential pair of characters matching; a gradual degradation factor via time per table due to ‘people moving’ since the origin of the record; a county's historical variance from the norm factor; a duplication potential factor (Tom Jones Jr. & Tom Jones living at same residence); a signature fraud factor; and an “autofills used” factor. It is understood that any number of factors may be used. It is further understood that out-of-our-hands factors may be accounted for in the programming. For example, at the BOE, loosely subjective human minds do a comparison of signatures for final approval of a validation. There are instances where all data matches but the signatures are apparently forged by the petition gatherer or an impostor signatory. This is an example of a statistically non-trivial, out-of-our-hands factor.

In certain embodiments, the processor 14 may include a storage device 24. The storage device 24 may be a single storage device or may be multiple storage devices. Furthermore, the storage device 24 may be a solid state storage system, a magnetic storage system, an optical storage system or any other suitable storage system or device. It is understood that the storage device 24 is adapted to store the instruction set 21. Other data and information may be stored in the storage device 24, as desired.

The processor 14 may further include a programmable component 26. It is understood that the programmable component 26 may be in communication with any other component of the data analysis system 10 such as the user interface 16, for example. In certain embodiments, the programmable component 26 is adapted to manage and control processing functions of the processor 14. Specifically, the programmable component 26 is adapted to control the analysis of the signatory information 20. It is understood that the programmable component 26 may be adapted to store data and information on the storage device 24, and retrieve data and information from the storage device 24.

The user interface 16 provides a means for the petitioner (or associate/agent/user) to input the signatory information 20 into the data analysis system 10 for comparison, verification, and validation. In certain embodiments, the user interface 16 is a computer in data communication with the database 12. As a non-limiting example, the data analysis system 10 may be provided to the user in the form of a software suite or a web-based application. As a further example, the user interface 16 may include secondary devices such as a digital pen for recording signatures and an optical scanner (e.g. bar code reader) for scanning bar-coded petitions.

In certain embodiments, the user interface 16 includes a global positioning device 28 (e.g. GPS technology for determining a global address). It is understood that the global positioning device 28 can be separate from the user interface 16. As a non-limiting example, petitioners, equipped with global positioning device 28, can verify addresses on a real-time, ‘door to door’ basis (GPS is especially useful where the printed signatory information is illegible). It is understood that a position data captured by the positioning device 28 can be used along with a confirmation of ‘willingness to sign’ or ‘political leaning’, to provide a precise ‘walking guide’ for subsequent maneuvers of the political process.

In certain embodiments, the user interface 16 includes ancillary searching procedures. For example, during human input of the signatory information 20, a user can search the database 12 based on any combination of sequential characters, even middle of the word characters, in two or more fields, which returns a popup of any potential records (i.e. matches) that meet all of the inputted patterns. By subsequently selecting one of the matches, the user interface 16 autofills a portion of the data in a signatory record, and marks the record as such. The user interface 16 also registers a cumulative tally per input personnel for use in their evaluation (a management tool/report).

The user interface 16 may also generate a feedback report 30 to the user. The feedback report 30 may include: an individual petitioner report showing at least one of signatures per shift/hour, valid signatures per shift/hour, overall percentage of valid signatures, and a time/date stamp ‘when last evaluated’, which aids in identifying petitioners who require additional training or who should be released from employment for efficiency reasons; an office report showing cumulative information for all petitioners in a particular office; a daily review report showing central office management a quick review of overall and individual field office numbers along with ‘notes’ from field office directors (can be retrieved for any given day); and an overall report showing progress for every county and closeness to meeting the rules for success in a campaign (e.g. can be date-ranged or to-date, per-office or overall, columns chosen, and output format choices (normal, printable, csv for excel)). It is understood that color changes of any cell text may be used to indicate problem areas or ‘rule met’ conditions, etc.

In practice, the user inputs each set of the signatory information 20 into the data analysis system 10 with the user interface 16. The processor 14 receives the signatory information 20 and analyzes the signatory information 20 based upon a rules-based model 22, with diverging paths, wherein the rules represent a number of queries 32 on the database 12. It is understood that the queries 32 are derived from the influential elements 23 and other comparison fields between the signatory information 20 and the official records 18. Specifically, each of diverging paths of the model leads to a numerical assignment, which, when added to the sum of any static and fluctuating factors, results in the final confidence rating 34. It is understood that the confidence rating 34 includes a validity threshold, wherein any rating above the threshold is categorized as a valid signature (i.e. a ‘fuzzy’ positive). It is further understood that a self-adjusting Margin of Error (MOE) can be applied based on number of sets of the signatory information 20 in a particular dataset.

In certain embodiments, both a signature associated with the signatory information 20 and a signature on record (delivered via Digital Pen or file) are converted to a digital image (e.g. bitmap, pnm files for netpbm, wpmg for GD or WAP, bmp for Microsoft Windows®). A rules-based system (signature comparison) of tests utilizes the available bitmap primitives and a proprietary code is then applied in a scale-independent method to loosely approximate human comparison. During the comparison process a “rules-results” record can be generated, which can be kept for later comparisons or identification. As a further example, the signature comparison may include at least one of the following tests: box-decimal width to height ratio of box including all extremity elements; number of complete lines in signature; number of completely enclosed areas; number of short lines and dots; slant or vector sum (depending on platform); number of clean vertical breaks (number of distinct horizontal “sections”); number of recognizable characters; absolute density-number of bits filled relative to an absolute (standard being 96 dpi 0.75×3 inch field); and a left-to-right traversal density fingerprint. It is understood that a sample of the total number of sets of the signatory information 20 may be used along with statistical extrapolation techniques to represent the total available signatory information. However, a complete “blanket” analysis of each of set of the signatory information 20 may be used.

In certain embodiments, the data analysis system 10 is also coded to handle various simultaneous and distinct campaigns, utilizing graphical, background coloration, and border color “themes” which are distinct and consistent for each campaign when inputting the signatory information 20, inputting personnel etc., or reviewing information in reports.

The data analysis system 10 and methods of the present invention provide a means to validate a number of the sets of the signatory information 20 in a near real-time environment. The results of the validation procedure may be used by petitioners prior to submission of a petition to the BOE. Accordingly, the petitioner minimizes the over-collection of signatures and thereby minimizes a cost of petitioning. Additionally, the system 10 and methods provide a means to compare information retrieved in real-time to stored information in order to minimize database information degradation.

The system 10 and method of the present invention aid in the collection of “signatures” (usually containing various signatory information) for political process referenda, recalls, and constitutional amendments. Specifically, the system 10 and method of the present invention provide a means to tally, organize, and report in a clear managerial fashion a number of ‘valid’ signatures collected.

Although the present disclosure is directed to petitions and the signatory validation process, it is understood that the data analysis system 10 may be applied to a variety of situations including fraud prevention in places where there are language barriers or where illiteracy is a problem (signature comparison rules used on a person's ‘mark’ combined with GPS, etc.). Additionally, the system 10 cumulatively maintains data that is inputted and amasses a growing record of the signatory information 20 and other personal data for the user (in compliance with relevant statute).

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A data analysis system comprising:
a database including a plurality of official records;
a user interface for receiving a signatory information; and
a processor in communication with the database and the user interface, wherein the processor compares the signatory information and a number of the official records based upon an instruction set and assigns a confidence factor to the signatory information in response to the comparison of the signatory information and the number of the official records.

2. The system according to claim 1, wherein each of the official records includes an identification data associated with a particular person.

3. The system according to claim 1, wherein the signatory information includes a digital image of a signature of a particular person.

4. The system according to claim 1, wherein each of the official records includes an abstract address and a global position associated with a particular household.

5. The system according to claim 1, further comprising a positioning device to determine a global position of the user interface at a time the signatory information is received thereby.

6. The system according to claim 1, wherein each of the official records is stored in the database as a standardized and normalized set of indices against which the processor is coded to search.

7. The system according to claim 1, wherein the instruction set includes an artificial intelligence algorithm having a plurality of influential elements by which the signatory information and the number of official records are compared.

8. The system according to claim 1, wherein the instruction set includes a rules-based model with diverging paths.

9. The system according to claim 8, wherein a plurality of rules of the rules-based model represent a number of queries on the database.

10. A method for validating signatory data, the method comprising the steps of:
a) providing a database including a plurality of official records;
b) providing a user interface for receiving a signatory information;
c) comparing the signatory information to a number of the official records; and
d) assigning a confidence factor to the signatory information based upon step c).

11. The method according to claim 10, wherein each of the official records includes an identification data associated with a particular person.

12. The method according to claim 10, wherein each of the official records includes an abstract address and a global position associated with a particular household.

13. The method according to claim 10, further comprising the step of determining a global position of the user interface at a time the signatory information is received thereby.

14. The method according to claim 10, further comprising the step of converting at least a portion of the signatory information into a digital image.

15. The method according to claim 10, wherein step c) is executed by an artificial intelligence algorithm having a plurality of influential elements by which the signatory information and the number of official records are compared.

16. The method according to claim 10, wherein step c) is executed by a rules-based model with diverging paths, a plurality of rules of the rules-based model representing a number of queries on the database.

17. A method for validating signatory data, the method comprising the steps of:
providing a database including a plurality of official records wherein each of the official records includes an identification data associated with a particular person;
providing a user interface for receiving a user-provided signatory information;
generating a model for comparing the signatory information to at least a portion of the official records;
assigning a confidence factor to the signatory information based upon the model; and
validating the signatory information based upon a threshold value for the confidence factor.

18. The method according to claim 17, further comprising the step of determining a global position of the user interface when the signatory information is received thereby.

19. The method according to claim 17, further comprising the step of converting at least a portion of the signatory information into a digital image.

20. The method according to claim 17, further comprising the step of generating a feedback report through the user interface.
